(19) United States
(12) Patent Application Publication
(10) Pub. No.: US 2009/0322937 A1
(43) Pub. Date: Dec. 31, 2009

(54) SEALED CAMERA ASSEMBLY AND HEAT REMOVAL SYSTEM THEREFOR

(75) Inventors: Kevin L. Young, Idaho Falls, ID (US); Robert D. Seifert, Idaho Falls, ID (US)

Correspondence Address: BATTELLE ENERGY ALLIANCE, LLC, P.O. BOX 1625, IDAHO FALLS, ID, 83415-3899, US

(73) Assignee: BATTELLE ENERGY ALLIANCE, LLC, Idaho Falls, ID (US)

(21) Appl. No.: 12/116,394

(22) Filed: May 7, 2008

Related U.S. Application Data
(63) Continuation-in-part of application No. 10/623,372, filed on Jul. 17, 2003, now abandoned.

(51) Int. Cl. H04N 5/225

(52) U.S. Cl. 348/373; 348/E05.026

(57) ABSTRACT

Sealed camera apparatus may include a generally closed chamber having at least one transparent window provided therein. A video camera mounted within the generally closed chamber receives light transmitted through the at least one transparent window. A radio transmitter mounted within the generally closed chamber is operatively associated with the video camera. A heat conduit having a first end and a second end extends through an opening provided in the generally closed chamber so that the first end of the heat conduit is located interior to the generally closed chamber and so that the second end of the heat conduit is located exterior to the generally closed chamber. The first end of said heat conduit is in thermal contact with at least a portion of the radio transmitter so that heat from the radio transmitter is transferred to the heat conduit. A heat sink mounted to the second end of the heat conduit dissipates heat from the transmitter and conducted through the heat conduit.

### CROSS-REFERENCE TO RELATED APPLICATION

This is a continuation-in-part of co-pending U.S. patent application Ser. No. 10/623,372, filed on Jul. 17, 2003, which is hereby incorporated herein by reference for all that it discloses.

### CONTRACTUAL ORIGIN OF THE INVENTION

This invention was made with United States Government support under Contract No. DE-AC07-05ID-14517 awarded by the United States Department of Energy. The United States Government has certain rights in the invention.

### TECHNICAL FIELD

This invention relates to communications systems in general and more specifically to communications systems for use in harsh and hazardous environments.

### BACKGROUND

Emergency response organizations are often required to work in hazardous or harsh environments. When direct sight of the hazardous environment and actions performed by rescue teams is not available, a portable camera system may be the only means for personnel monitoring the rescue teams to assess the hazardous environment acted upon by the rescue teams. The quality of images and the number of point of views available using the portable camera system often determines what can realistically be achieved by the rescue teams.

In one approach, Remote Surveillance Systems (RSS) having video monitoring, audio communications, and telemetric data management provide active monitoring of tasks performed in a hazardous environment. Sensory devices transmit video, audio and telemetric signals to a monitoring station. Trained personnel may then supervise controlled network activities from the monitoring station. Several monitoring stations may be established through a controlled area based on preference and work activity.

One practical limitation of RSS is physical connection with the monitoring station. In most cases, the RSS is linked to the monitoring station via cables. These cables have to be managed through specially-designed equipment to insure proper deployment of the RSS within its environment. An ill-designed cable management system can impair rescue tasks from being efficiently executed.

In another approach, helmet mounted wireless camera systems are used by personnel entering hazardous environments. Information gathered by a helmet mounted camera system is transmitted to a remote location for surveillance. However, helmet mounted camera systems are cumbersome and difficult to use in combination with hazardous protective suits worn by personnel entering a hazardous environment.

Furthermore, traditional wireless cameras having a receiver with a single antenna are more likely to encounter signal interference, known as multi-path interference, which may cause degradation of received images. Furthermore, users of a hand-held wireless camera may be constantly moving, thereby compounding signal degradation.

### SUMMARY OF THE INVENTION

One embodiment of a sealed camera apparatus may include a generally closed chamber having at least one transparent window provided therein. A video camera mounted within the generally closed chamber receives light transmitted through the at least one transparent window. A radio transmitter mounted within the generally closed chamber is operatively associated with the video camera. A heat conduit having a first end and a second end extends through an opening provided in the generally closed chamber so that the first end of the heat conduit is located interior to the generally closed chamber and so that the second end of the heat conduit is located exterior to the generally closed chamber. The first end of said heat conduit is in thermal contact with at least a portion of the radio transmitter so that heat from the radio transmitter is transferred to the heat conduit. A heat sink mounted to the second end of the heat conduit dissipates heat from the transmitter conducted through the heat conduit.

Also disclosed is an apparatus having a generally closed chamber having a heat source provided therein. A heat conduit having a first end and a second end extends through an opening provided in the generally closed chamber so that the first end of the heat conduit is located interior to the generally closed chamber and so that the second end of the heat conduit is located exterior to the generally closed chamber. The first end of the heat conduit is mounted to the heat source so that heat from the heat source is transferred to the heat conduit. A heat sink mounted to the second end of the heat conduit dissipates heat from the heat source conducted through the heat conduit.

Also disclosed is a heat removal system for conducting heat from a heat source located within a generally closed chamber to a location outside the chamber. More specifically, the heat removal system may comprise a heat conduit having a first end and a second end and sized to be received by an opening provided in the closed chamber so that the first end of said heat conduit is mounted to the heat source contained within the closed chamber. A heat sink is mounted to the second end of the heat conduit at a position that is exterior to the closed chamber.

### BRIEF DESCRIPTION OF THE DRAWING

Illustrative and presently preferred embodiment of the invention are shown in the accompanying drawing in which:

FIG. 1 is a high-level block diagram of a communication system in accordance with some embodiments of the present invention;

FIG. 2 is a high-level block diagram of a communication system in accordance with other embodiments of the present invention;

FIG. 3 is a block diagram of a camera apparatus shown in FIGS. 1 and 2;

FIG. 4 is a block diagram of a receiver apparatus shown in FIG. 1;

FIG. 4A is a block diagram of a receiver apparatus shown in FIG. 2;

FIG. 5 is a schematic of a power-relay unit configured to supply power to the receiver apparatuses shown in FIGS. 4-4A in accordance with some embodiments;

FIG. 6 is a block diagram of an extension link receiver apparatus shown in FIG. 2;

FIG. 7 is a block diagram of a monitoring unit shown in FIGS. 1 and 2;

FIG. 8 is a flowchart describing a methodology of transmitting video signals between remote locations according to some embodiments;

FIG. 9 is a pictorial representation of another embodiment of a communication system having a sealed camera assembly and heat removal system;

FIG. 10 is a block diagram of the communication system illustrated in FIG. 9;

FIG. 11 is a sectional view in elevation of the sealed camera assembly taken along the line 11-11 of FIG. 9 showing the various components of a heat removal system; and

FIG. 12 is an enlarged sectional view in elevation of a heat conduit of the heat removal system illustrate in FIG. 11.

### DETAILED DESCRIPTION OF THE PREFERRED EMBODIMENTS

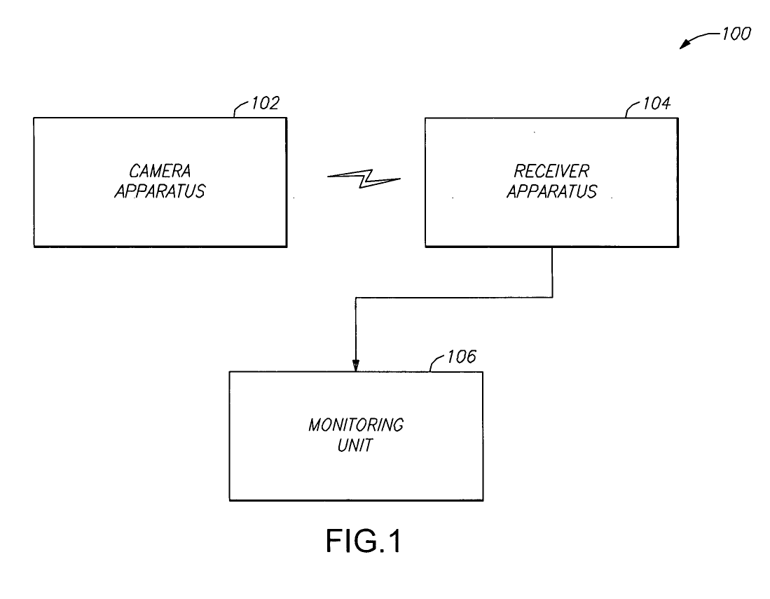

FIG. 1 is a high-level schematic of a communication system 100 according to one embodiment of the present invention. Communication system 100 includes a camera apparatus 102, a receiver apparatus 104, and a monitoring unit 106.

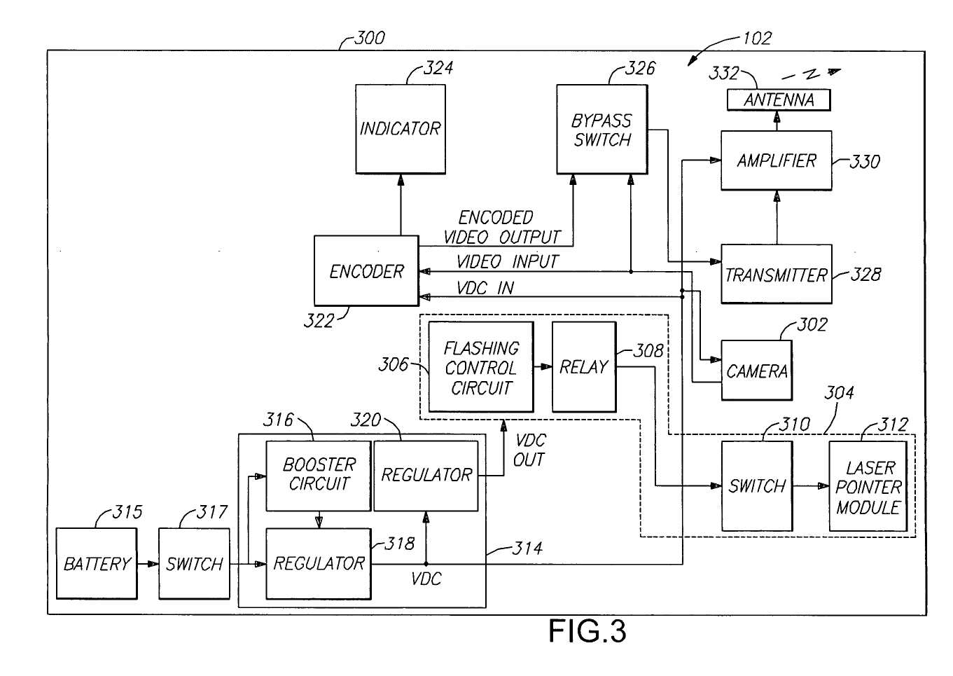

Camera apparatus 102 may be a video camera configured to capture and transmit video data/signals in real-time to receiver apparatus 104. In an exemplary embodiment, camera apparatus 102 is in wireless communication with receiver apparatus 104. For example, video signals captured by the camera apparatus 102 may be transmitted from the camera apparatus 102 to the receiver apparatus 104 in the form of radio frequency (RF) signals. Further details regarding the camera apparatus 102 are set forth below with regard to FIG. 3.

Receiver apparatus 104 is configured to receive video signals transmitted from the camera apparatus 102. In one exemplary embodiment, camera apparatus 102 and receiver apparatus 104 are configured to have a communication range of up to about 2200 feet line-of-sight without encountering degradation in signal reception of video signals transmitted from the camera apparatus 102.

Monitoring unit 106 is configured to receive video signals from the receiver apparatus 104 for monitoring purposes by personnel located remote from a location of the camera apparatus 102. In one exemplary case, communication between receiver apparatus 104 and monitoring unit 106 may be implemented via a cable. Other modes of communication (e.g., wireless communication) between receiver apparatus 104 and monitoring unit 106 are possible.

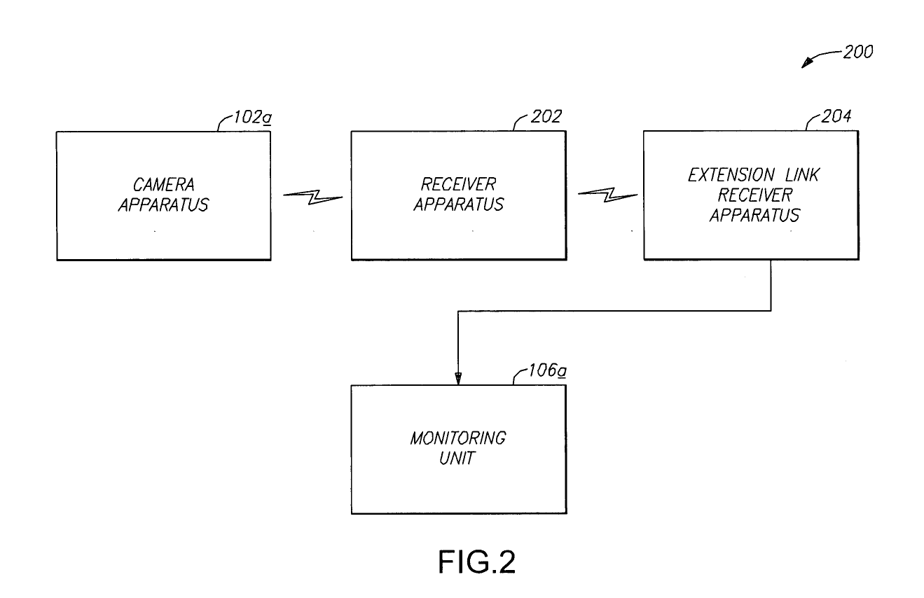

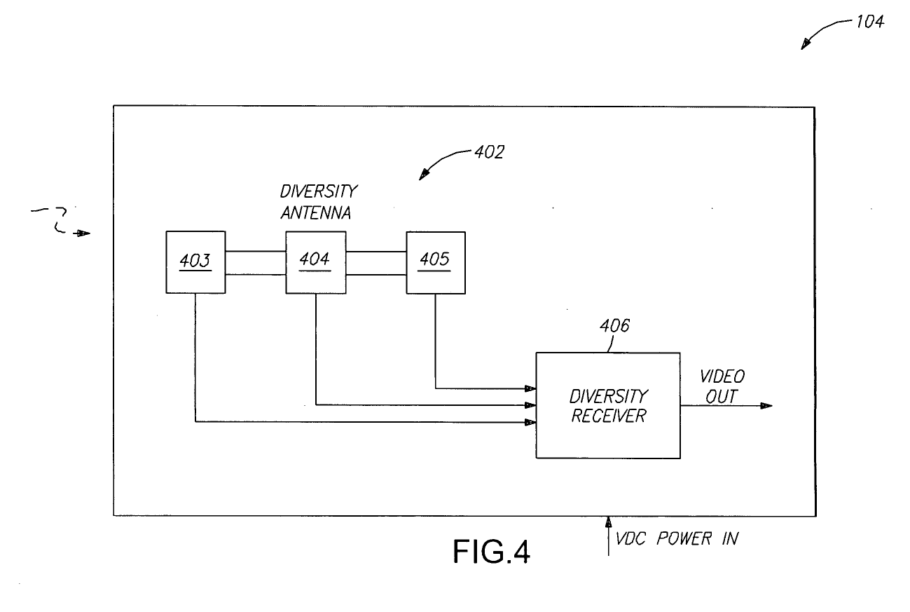

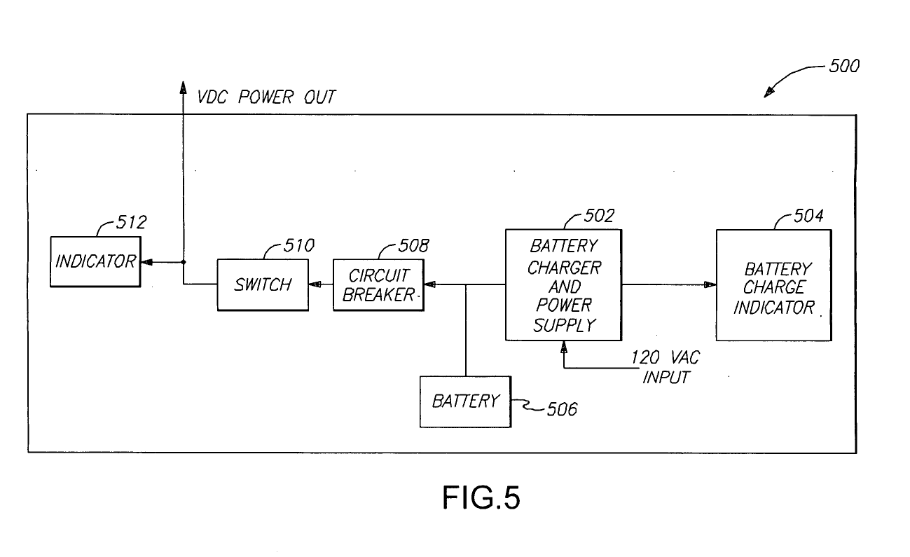

FIG. 2 is a high-level schematic of a communication system 200 in accordance with another embodiment wherein like elements shown in FIG. 1 are identified using like numerals, but with a suffix “a” added. Communication system 200 includes a camera apparatus 102a, a receiver apparatus 202, an extension link receiver apparatus 204, and a monitoring unit 106a. Video signals transmitted from the camera apparatus 102a and received by the receiver apparatus 202 may be further transmitted from the receiver apparatus 202 for reception by the extension link receiver apparatus 204. Video signals received by receiver apparatus 204 are provided for monitoring and display using the monitoring unit 106a. In one case, transmission range between receiver apparatus 202 and extension link receiver apparatus 204 is greater than about 4 miles line-of-sight. Further details of the receiver apparatus 202 are set forth below at FIG. 4A and details of extension link receiver apparatus 204 are set forth at FIG. 6.

In another embodiment, video signals received by the receiver apparatus 202 may be split into a plurality of paths (e.g., first and second paths). Video signals split into the first path may be provided to a first monitoring unit (e.g., such as monitoring unit 106), and video signals split into the second path may be further transmitted to a further remote location for reception by the receiver apparatus 204 and provided to the monitoring unit 106a.

FIG. 3 is a block diagram schematic of camera apparatus 102 shown in FIG. 1. Camera apparatus 102 may be disposed in a housing 300 including, inter alia, a housing defining a generally closed chamber. For example, housing 300 may be a waterproof housing defining a waterproof chamber. The housing 300 may be made of plastic. Other lightweight yet waterproof materials may also be used. Camera apparatus 102 includes a camera 302, laser flashing apparatus 304, a voltage regulator 314, a video encoder 322, an indicator 324 (e.g., encoder mode indicator), a bypass switch 326, (e.g., encoder bypass switch), a transmitter 328 (e.g., video transmitter), an amplifier 330 (e.g., radio frequency (RF) amplifier), and antenna 332. Components of the camera apparatus 102 listed herein are exemplary, and as such, more or less components may be utilized to achieve aspects of the invention without deviating from the scope of the various aspects of the invention.

Camera 302 may be a color video camera configured to capture video data. Camera 302 is alternatively referred to as video camera. For example, the camera 302 may be a model VB21CSHRX-W36 available from Marshall Electronics. In one exemplary embodiment, video camera 302 may include laser flashing apparatus 304.

Laser flashing apparatus 304 includes flashing control circuitry 306 (e.g., flashing control circuit using a 555 timer integrated circuit), relay 308 (e.g., solid state relay), a switch 310, and a light source 312 (e.g., laser pointer module). The light source 312 may be used to identify a frame of reference (e.g., center) of an image, captured by the camera 302, to assist a user monitoring images captured by the camera 302. The control circuitry 306 is configured to control flashing (e.g., periodically turning-on and turning-off) of the light source 312 in order conserve energy drawn from a DC voltage source, such as battery 315. The battery 315 may be provided with a switch 317 to control supply of energy to various components of the camera apparatus 102. In an exemplary embodiment, relay 308 and switch 310 may be used to control flashing of the light source 312.

Voltage regulator 314 is configured to receive input voltage from the battery 315 and provide a regulated output voltage to various components of the video camera apparatus 102. In one embodiment, regulator 314 includes a booster circuit 316 configured to boost received input voltage from battery 315 from a first level to a second higher level. Voltage regulator 314 also includes regulator devices 318, 320 to generate different regulated output voltages for supply to various components of the camera apparatus 102. For example, regulator 318 may be configured to receive input voltage from the battery 315 and produce a first regulated output voltage (e.g., 12 volts) supplied to camera 302 and amplifier 330. Regulator 320 may be configured to receive the first regulated output voltage from regulator 318 and produce a second regulated output voltage (e.g., 5 volts) that may be used by the laser flashing apparatus 304.

Encoder 322 is configured to encrypt video signals received from the video camera 302. The bypass switch 326 may be selectively set to be in one of two modes (e.g., an encrypted mode, or a bypass mode). If the bypass switch 326 is set to operate in encrypted mode, video signals from the video camera 302 are fed to encoder 322 for encryption, and encrypted video signals output from encoder 322 are fed to transmitter 328 via bypass switch 326. However, if the bypass switch is set to operate in a bypass mode, video signals from the video camera 302 are fed directly to the transmitter 328 via bypass switch 326 bypassing the encoder 322. An indicator device 324 is provided to indicate (e.g., flash green) when video signals from the video camera 302 are encrypted by the encoder 322 prior to transmission by the transmitter 328.

Transmitter 328 is configured to transmit video signals (e.g., either encrypted video signals received from encoder 322 or unencrypted video signals from the camera device 102). In one embodiment, transmitter 328 is configured to convert video signals (e.g., encrypted video signals as well as unencrypted video signals) to RF signals, and the RF signals may be amplified using amplifier 330 (e.g., RF amplifier) prior to transmission via antenna 332 (e.g., whip antenna). In one exemplary embodiment, amplified RF signals may be transmitted using transmitter 328 at a frequency of about 900 MHz and at a power level of about 200 mW. Other transmission frequencies and power levels are possible.

FIG. 4 is a block diagram schematic of receiver apparatus 104 according to one embodiment. The receiver apparatus 104 includes an antenna array 402, and a receiver 406.

The receiver apparatus 104 may be configured to receive RF signals (e.g., encrypted or unencrypted) transmitted from the camera apparatus 102. Antenna array 402 may be a triple-diversity antenna array having a plurality of antennas (e.g., patch antennas) 403, 404, 405. In one case, gain of individual patch antennas 403, 404, and 405 is at least 8 dB. RF signals received by antenna array 402 are fed to a receiver 406. The receiver 406 may be a true-diversity receiver configured to scan the RF signals received by the plurality of antennas 403, 404, 405 to determine an RF signal having increased signal strength among the RF signals received by individual antennas 403, 404, 405, respectively. Receiver 406 is configured to establish a lock on a RF signal determined to have increased signal strength. The receiver 406 is further configured to convert the locked RF signal into a composite video signal.

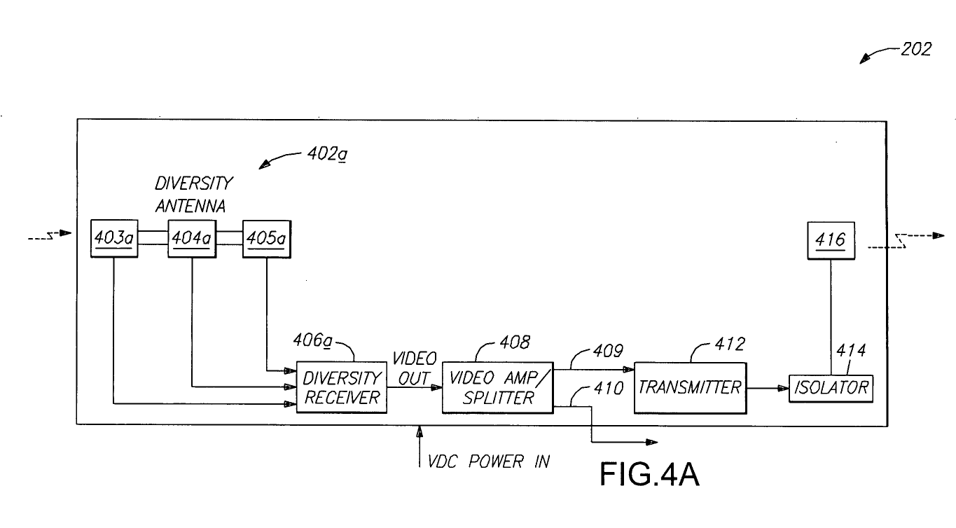

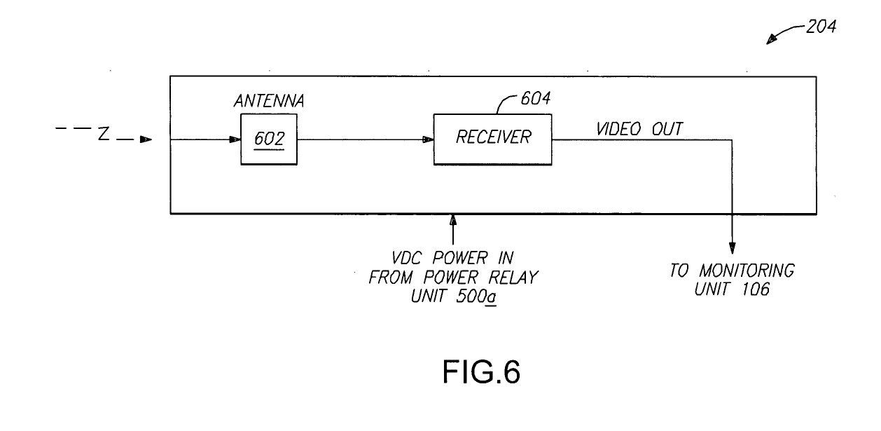

Video signals output from the receiver 406 may be provided to monitoring unit 106 (FIG. 1) for purposes of monitoring and display by personnel located remote from the camera apparatus 102. Further, details of the monitoring unit 106 are set forth below at FIG. 7. Power supply to the receiver apparatus 104 is provided from a battery source provided in a power relay box 500 (FIG. 5). In one embodiment, the power relay box 500 may be provided within receiver apparatus 104 or outside of the receiver apparatus, as desired. Further details of the power relay box 500 are described below at FIG. 5.

FIG. 4A is a block diagram schematic of an extension link receiver apparatus 202 in accordance with other embodiments of the invention, wherein elements like those illustrated in FIG. 4 are identified using like reference numerals, but with a suffix “a” added. The receiver apparatus 202 includes an antenna array 402a having a plurality of antennas 403a, 404a, 405a, a receiver 406a, a video amplifier/splitter 408, a transmitter 412, an isolator 414, and an antenna 416. Description of antenna array 402a and receiver 406a is similar to that provided as above with respect to FIG. 4, and therefore will not be repeated.

The video amplifier/splitter 408 is configured to receive and split the composite video signal output from receiver 406a into a plurality of feeds indicated by reference numerals 409 and 410. In some embodiments, video signals from video amplifier/splitter 408 (feed 410) may be provided to the monitoring unit 106 (FIG. 1) for monitoring and display. In other embodiments, video signals from video amplifier/splitter 408 (feed 409) may be provided to transmitter 412 for further transmission. In some other embodiments, video signals from video amplifier/splitter 408 may be monitored (e.g., connecting a monitoring unit 106 at feed 410) and further transmitted (e.g., feed 409 transmitted using transmitter 412). The further transmitted video signals may be subsequently received for further monitoring.

Power supply to receiver apparatus 202 may be provided from power relay unit 500a. In some embodiments, power replay unit 500a may be provided in the monitoring unit 106a. The power relay unit 500a may also be disposed outside the monitoring unit 106a, as desired. Further details of the monitoring unit 106 are set forth below with regard to FIG. 7.

Splitting of video signals by splitter 408 into a plurality of feeds (e.g., 409 and 410) may be performed if further transmission of video signals received by the receiver apparatus 202 is desired while providing a capability to monitor video signals output from video amplifier/splitter 408 (feed 410). However, if further transmission of video signals output from receiver 406a is not desired, then such video signals may be fed directly to the monitoring unit 106 for purposes of monitoring and display as described at FIG. 4. If further transmission of video signals received by receiver 202 is desired as noted above, then video signals at feed 409 are fed into transmitter 412 for further transmission. Transmitter 412 is configured to convert video signals received via feed 409 into RF signals. In an exemplary embodiment, transmitter 412 may be configured to transmit RF signals at a frequency of about 2.4 GHz. RF signals from transmitter 412 are passed through isolator 414 which is configured to protect the transmitter 412 from reflected power surges due to inadvertent removal of antenna 416. RF signals output from the isolator 414 are transmitted wirelessly using antenna 416 (e.g., patch antenna).

FIG. 5 is a schematic of a power-relay box 500 configured to supply DC power to receiver apparatuses 104 and 202 of communication systems 100 and 200, respectively. In one embodiment, the power relay box 500 includes a battery charger and power supply unit 502, a battery charge indicator 504, a battery 506, a circuit breaker 508, a power switch 510, and a power indicator device 512.

Unit 502 is configured to receive power supply from an external source (e.g., 120 volts AC supply) and charge the battery 506, when desired. Unit 502 may be implemented as a charging circuitry (not shown).

Indicator 504 is configured to an indication about the charging status of the battery 506. For example, indicator 504 may be configured as an LED, and a display of red color on the indicator 504 may indicate that a fault exists in unit 502, a display of green color on the indicator 504 may indicate that the battery has been completely charged by unit 502, and a display of amber color on the indicator 504 may indicate that the battery is currently being charged by unit 502.

Circuit breaker 508 may be provided to ensure supply of a constant output voltage from the battery 506. In the event of a power surge, the circuit breaker 508 may be configured to trip, thereby opening the circuit to disable supply of power from the battery 506.

A power switch 510 may be used to control supply of voltage from the battery 506.

An indicator 512 is provided to display an indication of voltage supply from the battery 506. For example, a red display by the indicator 512 may indicate that no voltage is being supplied from the battery 506, and a green display may indicate that voltage is being supplied from the battery 506.

FIG. 6 is a block diagram schematic of extension link receiver apparatus 204 shown in FIG. 2. In one embodiment, the receiver apparatus 204 includes an antenna 602 (e.g., a patch antenna), and a receiver 604. RF signals transmitted by transmitter 412 (FIG. 4A) are received by the receiver 604 via antenna 602. In one case, antenna 602 has a gain of about 14 dB. The receiver 604 converts the received RF signals into composite video signals. Video signals output from the receiver 604 may be received by the monitoring unit 106 (FIG. 2) via a cable. Other ways of providing video signals from the receiver apparatus 204 to the monitoring unit 106 are possible (e.g., wireless or optical transmission). Further details of the monitoring unit 106 are set forth below with regard to FIG. 7.

FIG. 7 is a block diagram schematic of a monitoring unit 106 in accordance with one embodiment. The monitoring unit 106 may be used for purposes of monitoring and display of video signals from receiver apparatuses 104 or 204 in accordance with various embodiments of the invention as set forth in FIGS. 1-2. In one embodiment, monitoring unit 106 includes a monitoring device 701 and a power relay unit 500a, wherein like elements shown in FIG. 5 are identified using like numerals, but a suffix “a” added. The monitoring unit 106 may be used in the following cases:

### Case 1:

In the embodiment shown in FIG. 4, encrypted video signals may be output from the receiver 406 and provided as input to decoder 702 of the monitoring unit 106.

### Case 2:

In the embodiment shown in FIG. 4A, encrypted video signals may be output as video signal feed 410 and provided as input to decoder 702 of the monitoring unit 106.

### Case 3:

If encrypted video signals are further transmitted using transmitter 412 as shown in FIG. 4A, and received using the receiver apparatus 204 (FIG. 6), encrypted video signals output from receiver 604 (FIG. 6) may be provided as input to decoder 702. After encrypted video signals are received by decoder 702, the rest of the operation of the circuitry shown in FIG. 7 is common to the above noted cases 1-3, and will be described below.

In one embodiment, the monitoring device 701 includes a decoder 702, a decoder status indicator 704, a video amplifier/splitter 706, and a video monitor 710.

Decoder 702 is configured to decrypt encrypted video signals received as input by the decoder 702. Decrypted video signals are provided to a video amplifier/splitter 706.

Decoder status indicator 704 may be a display indicator (e.g., LED diode, etc.) to display decoding status of encrypted video signals by decoder 702.

Video amplifier 706 may be configured to amplify split video signals received from decoder 702 into a plurality of feeds indicated by reference numerals 707 and 708. Video signals indicated at feed 707 may be displayed on a monitor 710, and video signals indicated at feed 708 may be provided to a video recording device (e.g., VCR, DVD recorder, etc.) (not shown) for recording purposes.

Power supply to monitoring device 701 is provided by power relay box 500a. In one embodiment, the power delay box 500a may be provided within the monitoring unit 106. Details of the power relay box 500 were described above at FIG. 5, and therefore will not be repeated.

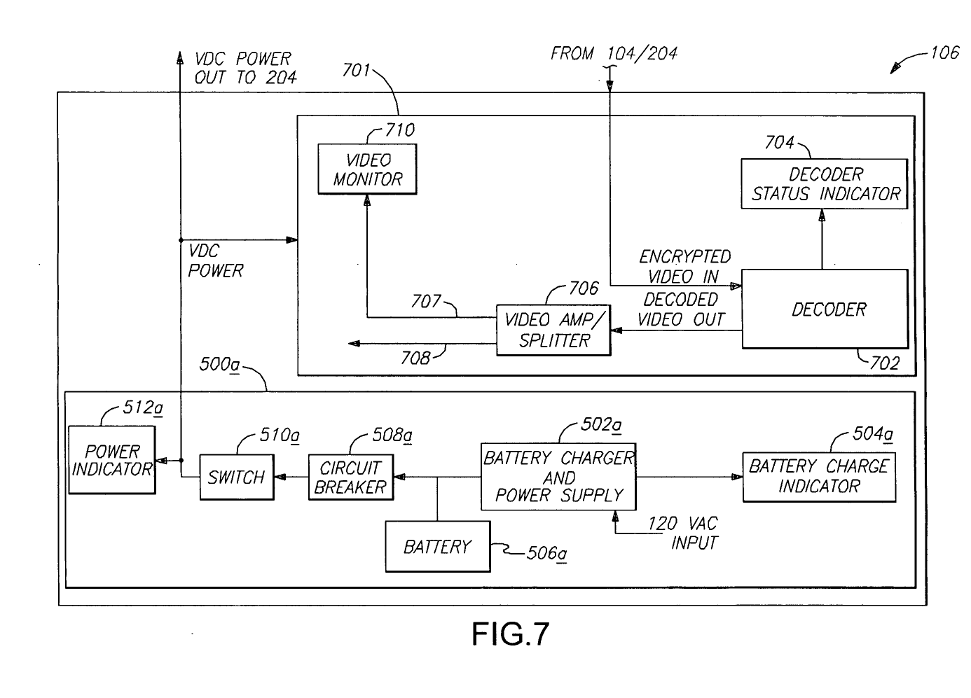

FIG. 8 is a flowchart describing a methodology of transmitting video signals between remote locations in accordance with some embodiments of the invention.

At a step 802, voltage received from a battery source (e.g., battery 315) is regulated. Step 804 is then performed.

At a step 804, the regulated voltage is provided to a camera (e.g., video camera 302).

At a step 806, video signals are captured using the video camera.

At a step 808, captured video signals are selectively encrypted, as desired.

At a step 810, video signals (e.g., encrypted or unencrypted) are transmitted using a first transmitter (e.g., transmitter 328).

At a step 812, the transmitted video signals are received using a diversity antenna array (e.g., antenna array 402 of receiver apparatus 104).

At a step 814, diversity receiver 406 of the receiver apparatus 104 is used to establish a lock on a video signal received by the diversity antenna array.

At a step 816, an inquiry is made to determine further transmission of video signals received by the first receiver apparatus. Step 818 is performed if no further transmission of the video signals is desired. Step 820 is performed if further transmission of the video signals is desired.

At a step 818, the received video signals are displayed and monitored using a monitoring unit.

At a step 820, the received video signals are further transmitted (e.g., using a second transmitter 412, also referred to as extension link transmitter).

At a step 822, the further transmitted video signals are received using a receiver (e.g., extension link receiver apparatus 204) and displayed for monitoring as indicated at step 818.

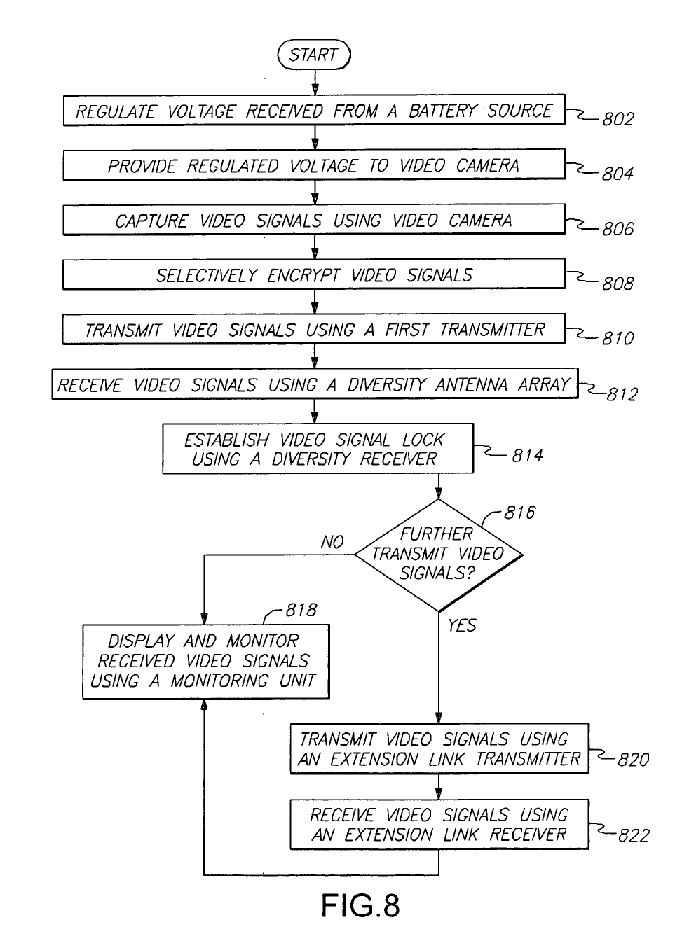

Another embodiment of communication apparatus 1010 is illustrated in FIG. 9 and may comprise a sealed camera assembly 1012 and a receiver 1014. Sealed camera assembly 1012 may send data 1016 (e.g., video and/or sound data, as well as other types of data, as will be described in greater detail below) to receiver 1014 via a wireless data link 1018. At least part of the data 1016 may be displayed on a suitable display system 1020 operatively associated with receiver 1014.

Sealed camera assembly 1012 also may be provided with heat removal system 1022. Heat removal system 1022 transfers or conducts heat generated by components (e.g., electronic components) internal to the sealed camera assembly 1012 to an environment external to the sealed camera assembly 1012. As will be described in greater detail below, heat removal system 1022 allows heat produced by components contained within the sealed camera assembly 1012 (e.g., within an interior region 1024 defined by a housing 1026 of sealed camera assembly) to be easily and effectively removed without the danger of compromising the seal between the interior 1024 of sealed camera assembly 1012 and the external environment.

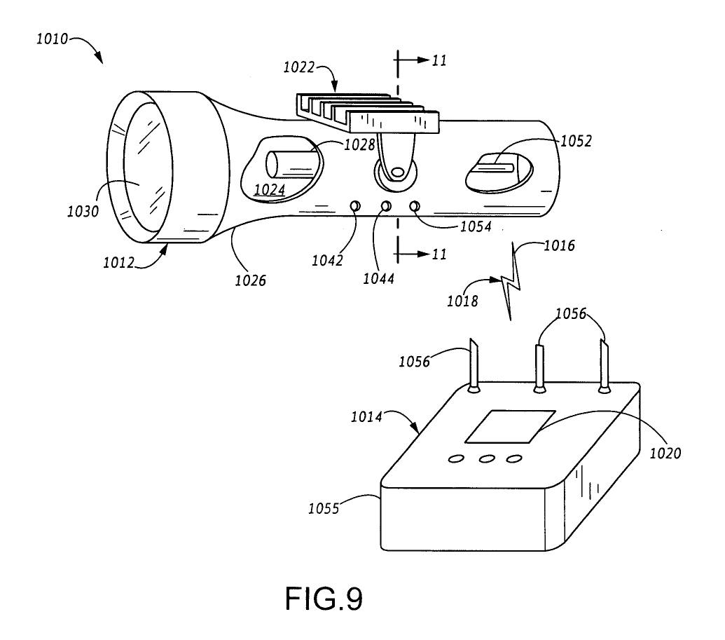

Referring now primarily to FIG. 10, sealed camera assembly 1012 may be provided with any of a wide variety of systems and components to allow the sealed camera assembly 1012 to capture data 1016 and transmit the data 1016 to receiver 1014 via wireless data link 1018. More specifically, in one embodiment, sealed camera assembly 1012 is provided with a video camera or sensor 1028. The video camera or sensor 1028 is mounted within housing 1026 of sealed camera assembly 1012 so that the camera 1028 is substantially aligned with a window 1030 provided in housing 1026. A radio transmitter 1032 operatively associated with video sensor 1028 receives video signals 1034 from video sensor 1028 and transmits those video signals 1034 as data 1016 over wireless data link 1018.

In the embodiment shown and described herein, radio transmitter 1032 comprises a dual power radio transmitter that is operable in either of a low power transmission mode or a high power transmission mode. Generally speaking, it will be preferable to operate the radio transmitter 1032 in the low power transmission mode in order to maximize battery life. However, certain circumstances may arise wherein it would be desirable to operate the radio transmitter 1032 in the high power transmission mode. For example, if additional range is required, then dual power radio transmitter 1032 may be operated in the high power transmission mode. Similarly, “noisy” environments, e.g., containing substantial amounts of radio-frequency (rf) interference, may also make it desirable to operate the dual power radio transmitter 1032 in the high power transmission mode.

Sealed camera assembly 1012 may also be provided with a memory system or “flash” memory storage module 1036 capable of storing data (e.g., video data) from video sensor 1028. The flash memory system or module 1036 may be removable from sealed camera assembly 1012 to allow data stored therein to be accessed. Flash memory system 1036 thereby allows data captured by video sensor 1028 to be accessed independently. The ability to independently access captured video data can be particularly useful where transmission via wireless data link 1018 is not possible or desirable. Alternatively, flash memory storage modules are available that include an integral video camera. In another embodiment, the flash memory storage module 1036 may comprise a flash storage module having an integral video camera in order to provide redundancy.

Sealed camera assembly 1012 may also be provided with an encryption system 1038 to allow the data from the video sensor 1028 to be encrypted before it is transmitted over the wireless data link 1018. Camera assembly 1012 may also be provided with one or more auxiliary data sensors 1040 suitable for sensing other conditions or factors and for producing data related to such other conditions or factors. Examples of such auxiliary data sensors 1040 include, but are not limited to, temperature sensors, microphones, and radiation sensors. The auxiliary data sensor(s) 1040 may be operatively associated with radio transmitter 1032 to allow data from the auxiliary data sensor 1040 to be transmitted over the wireless data link 1018.

The various electronic components and systems mounted within the interior 1024 of housing 1026 will, of course, produce heat during normal operation and thereby constitute a heat source. The heat produced by the various components particularly components within the interior 1024 needs to be dissipated from the generally closed chamber defined by the housing 1026 in order to avoid damaging or shortening the lives of such components. Of particular significance in this regard is the operation of the radio transmitter 1032 in the high power transmission mode, which can comprise a significant heat source requiring the dissipation of significant amounts of heat. The heat removal system 1022 provided to sealed camera assembly 1012 is used to remove or carry away the heat produced by the components contained within the interior 1024 of housing 1026 and dissipate the heat to the external environment.

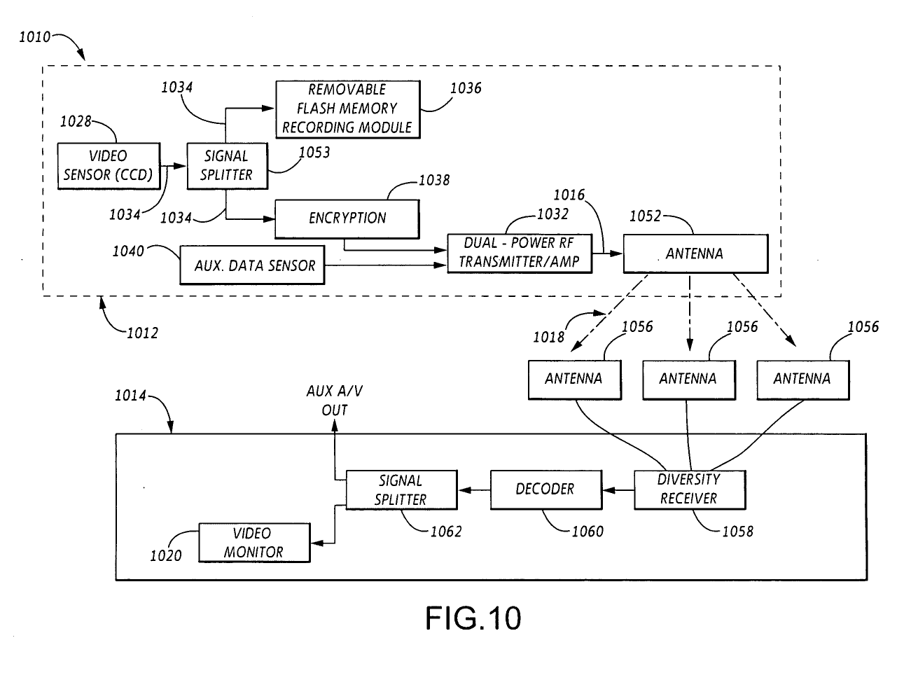

Referring now primarily to FIG. 11, the heat removal system 1022 may comprise a heat conduit 1046 that is sized to be received by an opening 1048 provided in housing 1026 of sealed camera assembly 1012. Heat removal system 1022 may also comprise a heat sink 1050 provided on the exterior of housing 1028. Heat sink 1050 is mounted to heat conduit 1046 in the manner best seen in FIG. 11. The heat producing components (e.g., the dual power radio transmitter 1032) contained within interior region 1024 of housing 1026 are mounted to the heat conduit 1046 so that heat produced by the components (e.g., radio transmitter 1032) will be efficiently conducted to the heat sink 1050, i.e., via heat conduit 1046.

Communication system 1010 may be used in a wide variety of applications and in a wide range of environments to transmit data 1016 (e.g., video data) to receiver 1014 via wireless data link 1018. For example, the sealed camera assembly 1012 is particularly well-suited for use in harsh or hostile environments in which an unprotected camera would be inoperative or would soon fail due to exposure to adverse environmental factors. More specifically, in the embodiment shown and described herein, the sealed camera assembly 1012 is waterproof, thereby allowing it to be readily used in wet or even submerged environments. If the sealed camera assembly 1012 is also designed to be gas-tight, then the sealed camera assembly could be used in atmospheres (e.g., corrosive or explosive atmospheres) that would otherwise be hazardous or have a deleterious effect on the various components provided within sealed camera assembly 1012.

Referring back now to FIG. 9, the sealed camera assembly 1012 may be activated by means of an on/off switch 1042 provided at a convenient location on the housing 1026 of sealed camera assembly 1012. Similarly, the transmitter 1032 may be switched between the low power transmission mode and the high power transmission mode by activating switch 1044, which may also be provided at a convenient location on housing 1026. Thereafter, the sealed camera assembly 1012 will transmit data 1016 (e.g., video data 1034 from video sensor 1028) to receiver 1014 via wireless data link 1018. Video data may be displayed on the display system 1020 provided on receiver 1014. If the sealed camera assembly 1012 is provided with an auxiliary data sensor 1040, such as a microphone, then receiver 1014 may be provided with a suitable audio transducer, such as a speaker or headphone set (not shown) to allow a user to hear sounds captured by the microphone.

As mentioned above, heat produced by the various electronic systems and components comprising sealed camera assembly 1012, particularly the radio transmitter 1032, will need to be dissipated during operation. The heat produced by such components is efficiently dissipated to the external environment by the heat removal system 1022. Significantly, heat removal system 1022 allows for the efficient conduction and dissipation of heat produced by the various electronic systems and devices contained within housing 1026 without compromising the environmental isolation provided by housing 1026.

Having briefly described communication system 1010 according to the present invention, as well as some of its more significant features and advantages, various exemplary embodiments of the communication system 1010 will now be described in detail. However, before proceeding with the detailed description, it should be noted that the communication system 1010 is shown and described herein as comprising a sealed camera assembly 1012 that is configured and sized to mimic or resemble a conventional flashlight. This configuration will allow for the convenient use of the sealed camera assembly 1012 by rescue and/or investigative personnel in a manner akin to a conventional flashlight, except that the sealed camera assembly 1012 would be used to capture video and/or other data from the particular scene or environment being investigated. Alternatively, other configurations for the sealed camera assembly 1012 could be used, as would become apparent to persons having ordinary skill in the art after having become familiar with the teachings provided herein. Consequently, the present invention should not be regarded as limited to the particular configurations and in the particular environments shown and described herein.

With reference primarily to FIG. 9, an exemplary embodiment of communication system 1010 may comprise a sealed camera assembly 1012 and a receiver assembly 1014. Sealed camera assembly 1012 may send data 1016 to receiver 1014 via wireless data link 1018. The data 1016 may then be displayed on a suitable display system 1020 associated with the receiver 1014.

As briefly mentioned above, the data 1016 transmitted to receiver 1014 may comprise any of a wide range of data types depending on the configuration of the particular system 10. For example, in the embodiment shown and described herein, the data 1016 sent by sealed camera assembly 1012 may comprise video data 1034 produced by video sensor 1028. In addition, the data 1016 may also comprise still image data and may or may not be provided with audio data, such as, for example, as may be captured by auxiliary data sensor 1040 (e.g., a microphone). Still other types of data may be sent, as will be described in further detail herein and as will become apparent to persons having ordinary skill in the art after having become familiar with the teachings provided herein. Consequently, the present invention should not be regarded as limited to any particular type of data.

Sealed camera assembly 1012 may comprise a housing 1026 sized to receive the various electronic systems and components that are to be utilized in the particular application. Housing 1026 may also be provided with a transparent “window” 1030 suitable for transmitting light of the desired wavelength range (e.g., visible, infra-red, ultra-violet, etc.) to the video sensor 1028 provided within the interior region 1024 of housing 1026. In addition, it is generally preferred, but not required, that housing 1026 comprise generally sealed construction in order to protect the various components provided therein from exposure to damaging or hostile environmental factors. Examples of sealed construction include, but are not limited to, waterproof construction and gas-tight construction, although other types of construction are possible, as would become apparent to persons having ordinary skill in the art after having become familiar with the teachings provided herein.

Housing 1026 may be fabricated from any of a wide range of materials, such as plastics, suitable for the environmental conditions expected to be encountered. Consequently, the present invention should not be regarded as limited to housings fabricated from any particular materials. However, by way of example, in one embodiment, housing 1026 is fabricated from ABS plastic. Window 1030 may also be fabricated from any of a wide range materials, such as plastic, glass, quartz, that would be suitable for the expected environment. By way of example, in one embodiment, window 1030 is fabricated from a transparent polycarbonate material (e.g., Lexan®). Suitable gaskets or seals (not shown) may also be provided to ensure that the window 1030 is water and/or gas-tight, as the case may be.

With reference now primarily to FIG. 10, with occasional reference to FIG. 9, sealed camera assembly 1012 may comprise a video camera or sensor assembly 1028 suitable for capturing images desired to be transmitted to receiver 1014. Examples of images that might be desired to be transmitted to receiver 1014 include, but are not limited to, black and white images, color images, so-called “false color” images, and infra-red image data. The image data may comprise moving picture image data (e.g., in the case of video image data) or may comprise still image data. Accordingly, video sensor 1028 may comprise any of a wide variety of video sensors of the type now known in the art or that may be developed in the future that are, or would be suitable or desirable, for the particular application. Consequently, the present invention should not be regarded as limited to any particular type of video sensor. However, by way of example, in one embodiment, video sensor 1028 may comprise a video camera produced by the Sony Corporation as model no. VB21CSHRX-W. Video sensor 1028 is mounted within housing 1026 so that it is aligned with window 1030 provided in housing 1026.

Sealed camera assembly 1012 may also be provided with a radio transmitter 1032. Radio transmitter 1032 is operatively associated with the video sensor 1028 and receives video signals 1034 from video sensor 1028. In the embodiment shown and described herein, radio transmitter 1032 comprises a dual power radio transmitter that is operable in either of a low power transmission mode or a high power transmission mode. As will be described in greater detail below, radio transmitter 1032 is mounted to the heat removal system 1022 which removes heat produced by the radio transmitter 1032, particularly during operation in the high power mode, and dissipates it to the surrounding environment via heat sink 1050.

Radio transmitter 1032 may comprise any of a wide range of radio transmitters now known in the art or that may be developed in the future that would be suitable for the intended application. Consequently, the present invention should not be regarded as limited to any particular radio transmitter. However, by way of example, in one embodiment, radio transmitter 1032 comprises a VNTX series transmitter, available from L3 Communications, Southern California Microwave, of San Diego, Calif. When operated in the low power transmission mode, this particular transmitter transmits at an RF power of about 400 milliwatts (mW). Transmitter 1032 transmits at an RF power of about 2 watts in the high power transmission mode. Generally speaking, transmission in the low power mode will provide a line-of-sight transmission distance of about 1000 meters (about 3,280 feet), whereas transmission in the high power mode will generally provide a line-of-sight transmission distance of about 2000 meters (about 6,562 feet).

An antenna 1052 operatively associated with radio transmitter 1032 is used to establish the wireless data link 1018. Antenna 1052 may comprise any of a wide range of antennas known in the art or that may be available in the future that are, or would be suitable for the intended application. By way of example, in one embodiment, antenna 1052 comprises an omnidirectional antenna available from Nearson, Inc. of Springfield, Va., as model no. S467TC-915. Advantageously, antenna 1052 may be mounted within interior region 1024 of housing 1026 if the housing 1026 is fabricated from a plastic material, such as ABS.

As mentioned above, sealed camera assembly 1012 may also be provided with a memory system, such as a “flash” memory module 1036 that is capable of storing data (e.g., video data 1034) from sensor 1028. Video data 1034 from sensor 1028 may be obtained via signal splitter 1053. It is generally preferred, but not required, that the flash memory system 1036 be removable from sealed camera assembly 1012 to allow data stored therein to be accessed without the need to transmit the video data via wireless data link 1018. Flash memory system 1036 may comprise any of a wide range of memory systems now known in the art or that may be developed in the future. In one embodiment, flash memory system comprises a flash memory recording module available from Oregon Scientific of Tualatin, Oreg.

Sealed camera assembly 1012 may also be provided with an encryption system 1038 to allow the data 1034 from video sensor 1028 to be encrypted before it is transmitted over the wireless data link 1018. Encryption system 1038 is positioned in series between signal splitter 1054 and radio transmitter 1032. Encryption system 1038 may be selectively turned on and off by means of a switch 1054 (FIG. 9). Encryption switch 1054 may be located at any convenient position on housing 1026, as best seen in FIG. 9. In the embodiment shown and described herein, encryption system 1038 may comprise a “Micro-ViewLock II” encryption system available from Ovation Systems, Ltd., of Oxfordshire, England. Alternatively, other types of encryption systems may be utilized.

Camera assembly 1012 may also be provided with one or more auxiliary data sensors 1040 capable of sensing other conditions or factors and for producing data related to such other conditions or factors. As mentioned above, examples of such auxiliary data sensors 1040 include temperature sensors, microphones, radiation sensors, and the like. Finally, camera assembly 1012 may be provided with one or more batteries (not shown) and/or a voltage regulator (also not shown) for providing electrical power to the various components and systems provided in sealed camera assembly. However, because such battery and/or voltage regulator systems are well-known in the art and could be easily provided by persons having ordinary skill in the art after having become familiar with the teachings provided herein, the particular battery and voltage regulator systems that may be utilized in one embodiment will not be described in further detail herein.

Receiver 1014 may be provided with a number of components and systems suitable for receiving data 1016 provided on the wireless data link 1018 between sealed camera assembly 1012 and receiver 1014. Moreover, the various components and systems comprising receiver 1014 may be mounted in a small housing or travel case 1055 to enhance portability. Still referring primarily to FIGS. 9 and 10, receiver 1014 may comprise a plurality of antennas 1056 (e.g., three antennas 1056), each of which is connected to a “diversity” receiver 1058. The combination of the plurality of antennas 1056 and diversity receiver 1058 improves the ability of the receiver 1014 to receive signals from sealed camera assembly 1012, particularly where obstacles may be present between camera assembly 1012 and receiver 1014. Alternatively, of course, a single receive/antenna system may also be used. Diversity receiver 1058 may comprise, for example, a receiver available from Coherent Communications of Valencia, Calif. as model no. CVR-1500. Each of the antennas 1056 may comprise an omnidirectional antenna available from Nearson, Inc. as model no. S467TC-915. In another embodiment, one or more of the antennas 1056 could comprise directional “patch” antennas, such as a directional patch antenna available from Coherent Communications as model no. AP-2.

Receiver 1014 may also be provided with a decoder system 1060 suitable for decoding the encryption codes provided by encryption system 1038. By way of example, in one embodiment, decoder system 1060 may comprise a “Micro-ViewLock II” decryption system available from Ovation Systems, Ltd. of Oxfordshire, England. Receiver 1014 may also be provided with a display system 1020, such as an LCD display, suitable for displaying video data received from sealed camera assembly 1012. Receiver 1014 may also be provided with a signal splitter 1062, if desired, to allow for a separate video signal output.

As mentioned above, sealed camera assembly 1012 may be provided with a heat removal system 1022 to remove heat generated or produced by a heat source including any of the various electronic systems and devices (e.g., components) provided within housing 1026 of sealed camera assembly 1012. The ability to efficiently remove heat produced by such components is significant in that it will extend the life and/or improve the reliability of such components. However, the fact that the components are provided within a generally sealed, non-metallic housing 1026 makes the removal and dissipation of heat difficult, in that the housing itself and the air contained within the interior space 1024 defined within the housing 1026 defining a generally closed chamber will not absorb and dissipate the heat produced by such components at a sufficient rate. Heat removal system 1022 provides a means for removing and efficiently dissipating the heat produced by the various components (e.g., heat sources) contained within housing 1026 without compromising the sealed integrity of housing 1026 and chamber defined thereby.

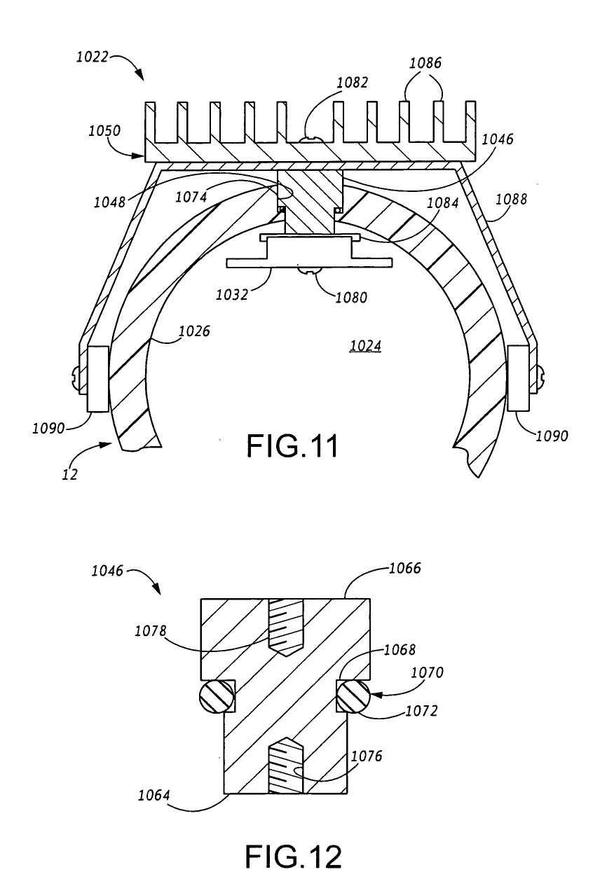

Referring now to FIGS. 11 and 12, heat removal system 1022 may comprise a heat conduit 1046 that is sized to be received by an opening 1048 provided in housing 1026 of sealed camera assembly 1012. In the embodiment shown and described herein, heat conduit 1046 comprises a generally cylindrically shaped member having a first end 1064 and a second end 1066. Heat conduit 1046 may be provided with a grooved section 1068 sized to receive a gasket 1070, such as an O-ring 1072, suitable for sealing a gap 1074 between heat conduit 1046 and opening 1048 in housing 1026. First and second ends 1064 and 1066 of heat conduit 1046 may be provided with respective threaded openings 1076 and 1078 for receiving fasteners, such as screws 1080, 1082, as best seen in FIG. 11.

Heat conduit 1046 may be fabricated from any of a wide range of materials, such as metals, that are good conductors of heat, as would become apparent to persons having ordinary skill in the art after having become familiar with the teachings provided herein. Consequently, the present invention should not be regarded as limited to a heat conduit 1046 fabricated from any particular material. However, by way of example, in one embodiment, heat conduit 1046 is fabricated from aluminum, although copper could be used as well. In this regard, it should be noted that in one embodiment, heat conduit 1046 comprises a generally solid member and does not contain a liquid heat transfer fluid.

As mentioned above, the various heat producing components (e.g. heat sources) contained within interior region 1024 of housing 1026 may be mounted so that they are in thermal contact with first end 1064 of heat conduit 1046. In this regard it may be desirable to mount those components that produce the most heat during operation to a suitable mounting plate or bracket 1084 that is configured to be mounted to first end 64 of heat conduit 1046, such as, for example, via screw 1080, as best seen in FIG. 11. Alternatively, other arrangements may be used, as would become apparent to persons having ordinary skill in the art after having become familiar with the teachings provided herein. More specifically, in the embodiment shown and described herein, the radio transmitter 1032 generates a significant amount of heat, particularly during operation in the high power transmission mode. Consequently, radio transmitter 1032 is mounted to bracket 84 so that heat produced by radio transmitter 1032 will be efficiently transferred to heat conduit 1046.

Referring now primarily to FIG. 11, the second end 1066 of heat conduit 1046 is mounted to a heat sink 1050 that is provided on the outside or exterior region of housing 1026. Heat sink 1050 may be provided with a plurality of fins 1086 to increase the surface area thereof, thus increase the heat dissipation capacity of heat sink 1050. Optionally, heat sink 1050 may also be secured to a support bracket assembly 1088 to provide additional mechanical support for heat sink 1050. Support bracket assembly 1088 may be secured to housing 1026 via a pair of mounting bosses 1090, as best seen in FIG. 11. Alternatively, other mounting arrangements could be used as well.

Heat sink 1050 may be fabricated from any of a wide range of materials, such as aluminum or copper, that are good conductors of heat, as would become apparent to persons having ordinary skill in the art after having become familiar with the teachings provided herein. Consequently, the present invention should not be regarded as limited to a heat sink 1050 fabricated from any particular material. However, by way of example, in one embodiment, heat sink 1050 is fabricated from aluminum.

Having herein set forth preferred embodiments of the present invention, it is anticipated that suitable modifications can be made thereto which will nonetheless remain within the scope of the invention. The invention shall therefore only be construed in accordance with the following claims:

1. A sealed camera apparatus, comprising:
a generally closed chamber having at least one transparent window provided therein;
a video camera mounted within said generally closed chamber so that said video camera receives light transmitted through the at least one transparent window provided in said generally closed chamber;
a radio transmitter mounted within said generally closed chamber, said radio transmitter being operatively associated with said video camera;
a heat conduit having a first end and a second end, said heat conduit extending through an opening provided in said generally closed chamber so that the first end of said heat conduit is located interior to said generally closed chamber and so that the second end of said heat conduit is located exterior to said generally closed chamber, the first end of said heat conduit being in thermal contact with said radio transmitter so that heat from said radio transmitter is transferred to said heat conduit; and
a heat sink mounted to the second end of said heat conduit, said heat sink dissipating heat from at least said radio transmitter and conducted through said heat conduit.

2. The apparatus of claim 1, wherein said generally closed chamber comprises a waterproof chamber.

3. The apparatus of claim 1, wherein said heat conduit comprises a generally cylindrically shaped member.

4. The apparatus of claim 1, further comprising a gasket operatively associated with said heat conduit and said generally closed chamber, said gasket sealing a gap between said heat conduit and said generally closed chamber.

5. The apparatus of claim 4, wherein said gasket comprises an O-ring.

6. The apparatus of claim 1, wherein said heat conduit comprises aluminum.

7. The apparatus of claim 1, wherein said heat sink comprises a plurality of fins.

8. The apparatus of claim 1, wherein said heat sink comprises aluminum.

9. The apparatus of claim 1, wherein said heat conduit lacks a liquid heat transfer fluid.

10. The apparatus of claim 1, wherein said heat conduit comprises at least one chosen from the group consisting of a metal and a metal alloy.

11. The apparatus of claim 1, further comprising:
a battery mounted within said generally closed chamber, said battery being operatively associated with said video camera and said radio transmitter; and
a flash memory module mounted within said generally closed chamber, said flash memory module being operatively associated with said video camera, said flash memory module storing video data from said video camera.

12. The apparatus of claim 11, wherein said transmitter comprises a dual power radio transmitter, said dual power radio transmitter being operable in a high power transmission mode and a low power transmission mode.

13. Apparatus, comprising:
a generally closed chamber;
a heat source provided within said generally closed chamber;
a heat conduit having a first end and a second end, said heat conduit extending through an opening provided in said generally closed chamber so that the first end of said heat conduit is located interior to said generally closed chamber and so that the second end of said heat conduit is located exterior to said generally closed chamber, the first end of said heat conduit being mounted to said heat source so that heat from said heat source is transferred to said heat conduit; and
a heat sink mounted to the second end of said heat conduit, said heat sink dissipating heat from said heat source and conducted through said heat conduit.

14. The apparatus of claim 13, wherein said heat sink further comprises a plurality of fins.

15. The apparatus of claim 13, wherein said generally closed chamber comprises a water-tight chamber.

16. The apparatus of claim 13, wherein said heat source comprises a plurality of electronic devices.

17. The apparatus of claim 16, wherein said plurality of electronic devices comprises at least a radio transmitter and at least a video camera.

18. The apparatus of claim 13, wherein said heat conduit lacks a liquid heat transfer fluid.

19. A heat removal system for conducting heat from a heat source located within a generally closed chamber to a location outside the chamber, comprising:
a heat conduit having a first end and a second end, said heat conduit being sized to be received by an opening provided in the chamber, the first end of said heat conduit being mounted to the heat source contained within the chamber; and
a heat sink mounted to the second end of said heat conduit, the heat sink being located exterior to the chamber.
